(19) United States
(12) Patent Application Publication
(10) Pub. No.: US 2026/0081078 A1
(43) Pub. Date: Mar. 19, 2026

(54) ELECTRONIC COMPONENT

(71) Applicant: TDK CORPORATION, Tokyo (JP)

(72) Inventors: Daisuke HIROTA, Tokyo (JP); Kazuya MIURA, Tokyo (JP); Yuta IMAI, Tokyo (JP); Noriyuki INOUE, Tokyo (JP); Koki KAGAWA, Tokyo (JP)

(73) Assignee: TDK CORPORATION, Tokyo (JP)

(21) Appl. No.: 19/325,033

(22) Filed: Sep. 10, 2025

(30) Foreign Application Priority Data
Sep. 19, 2024 (JP) 2024-162099

(51) Int. Cl. H01G 4/232; H01G 4/005; H01G 4/12; H01G 4/248; H01G 4/30

(52) U.S. Cl. CPC H01G 4/2325; H01G 4/12; H01G 4/248; H01G 4/30; H01G 4/005

(57) ABSTRACT

An electronic component includes an element body including a side surface, an internal conductor in the element body, and an external conductor on the side surface. The internal conductor includes an edge that is exposed at the side surface. The external conductor is connected to the edge of the internal conductor, and includes a first region, a second region, and a third region. The first region is in contact with the side surface, and is physically connected to the edge of the internal conductor. The first region includes an electrically conductive material. The second region is positioned on an outermost side of the external conductor, and includes an electrically conductive material. The third region is positioned between the first region and the second region, and is less permeable to hydrogen than the first region and the second region.

### CROSS-REFERENCE TO RELATED APPLICATIONS

This application is based upon and claims the benefit of priority from Japanese Patent Application No. 2024-162099, filed on Sep. 19, 2024, the entire contents of which are incorporated herein by reference.

### BACKGROUND

### Field

The present disclosure relates to an electronic component.

### Description of the Related Art

Known electronic components include an element body, an internal conductor, and an external conductor (see, for example, Japanese Unexamined Patent Publication No. 2003-243249). The element body includes a side surface. The internal conductor is disposed in the element body, and includes an edge that is exposed at the side surface. The external conductor is disposed on the side surface, and is connected to the edge of the internal conductor.

### SUMMARY

The electronic component may have a configuration in which a plating layer is formed on the external conductor. In a configuration in which the plating layer is formed on the external conductor, hydrogen may be generated when forming the plating layer. The generated hydrogen may diffuse into the element body through the external conductor. The hydrogen diffused into the element body may deteriorate the characteristics of the electronic component. For example, hydrogen diffused in the element body may reduce the insulation resistance.

An object of one aspect of the present disclosure is to provide an electronic component that suppresses deterioration in characteristics thereof, even when the electronic component has a configuration in which a plating layer is formed on an external conductor.

An electronic component according to one aspect of the present disclosure includes an element body, an internal conductor, and an external conductor. The element body includes a side surface. The internal conductor is disposed in the element body, and includes an edge that is exposed at the side surface. The external conductor is disposed on the side surface, and is connected to the edge of the internal conductor. The external conductor includes a first region, a second region, a third region. The first region is in contact with the side surface and is physically connected to the edge of the internal conductor, the first region including an electrically conductive material. The second region is positioned on an outermost side of the external conductor, and includes an electrically conductive material. The third region is positioned between the first region and the second region, the third region being less permeable to hydrogen than the first region and the second region.

In the one aspect, the external conductor includes the third region. The third region impedes hydrogen from migrating in the external conductor from the second region toward the first region. Therefore, hydrogen tends not to diffuse into the element body. The one aspect suppresses the deterioration of characteristics thereof.

In the one aspect, the external conductor includes the second region. The second region includes the electrically conductive material. Therefore, the plating layer is easily formed on the second region. The one aspect can easily adopt a configuration in which the plating layer is formed on the external conductor.

In the one aspect, the external conductor includes the first region. The first region includes the electrically conductive material. Therefore, the one aspect reliably maintains the electrical connection between the internal conductor and the external conductor.

### BRIEF DESCRIPTION OF THE DRAWINGS

FIG. 1 is a perspective view of a multilayer capacitor according to an example;

FIG. 2 is a view illustrating a cross-sectional configuration of the multilayer capacitor according to the example;

FIG. 3 is a view illustrating an external conductor;

FIG. 4 is a diagram illustrating an example of a process for forming the external conductor;

FIG. 5 is a diagram illustrating the example of the process for forming the external conductor;

FIG. 6 is a diagram illustrating the example of the process for forming the external conductor;

FIG. 7 is a view illustrating a cross-sectional configuration of a multilayer capacitor according to a modification of the example;

FIG. 8 is a diagram illustrating an example of a process for forming the external conductor;

FIG. 9 is a diagram illustrating the example of the process for forming the external conductor;

FIG. 10 is a view illustrating a cross-sectional configuration of a multilayer capacitor according to another modification of the example;

FIG. 11 is a diagram illustrating an example of a process for forming the external conductor;

FIG. 12 is a diagram illustrating the example of the process for forming the external conductor;

FIG. 13 is a view illustrating a cross-sectional configuration of a multilayer capacitor according to still another modification of the example;

FIG. 14 is a view illustrating an external conductor; and

FIG. 15 is a table illustrating insulation resistance test results.

### DETAILED DESCRIPTION

In the following description, with reference to the drawings, the same reference numbers are assigned to the same components or to similar components having the same function, and overlapping description is omitted.

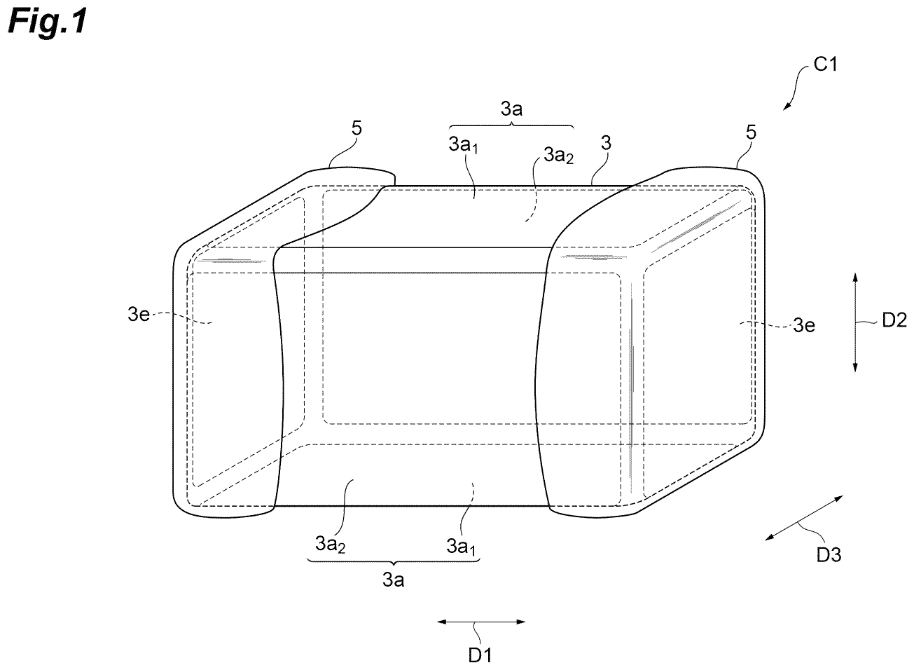

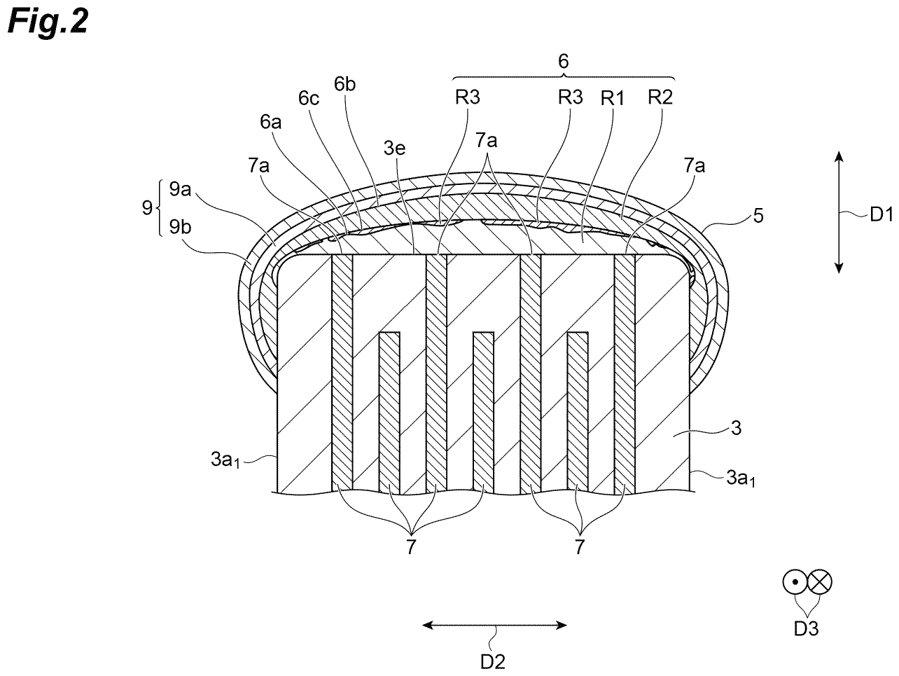

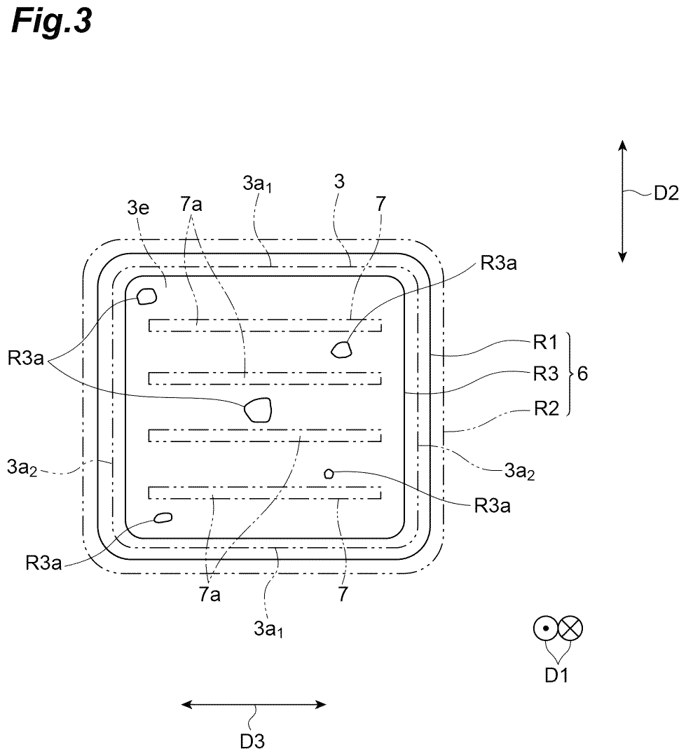

A configuration of a multilayer capacitor C1 according to the example will be described with reference to FIGS. 1 to 3. FIG. 1 is a perspective view of a multilayer capacitor according to the example. FIG. 2 is a view illustrating a cross-sectional configuration of the multilayer capacitor according to the example. FIG. 3 is a view illustrating an external conductor.

An electronic component includes, for example, the multilayer capacitor C1.

As illustrated in FIG. 1, the multilayer capacitor C1 includes an element body 3 and a plurality of external electrodes 5. For example, the multilayer capacitor C1 includes a pair of external electrodes 5. The pair of external electrodes 5 are disposed on a surface of the element body 3. The pair of external electrodes 5 are separated from each other. The element body 3 has a rectangular parallelepiped shape. The rectangular parallelepiped shape includes, for example, a rectangular parallelepiped shape in which corners and ridges are chamfered, or a rectangular parallelepiped shape in which the corners and ridges are rounded.

The element body 3 includes four side surfaces 3a and a pair of side surfaces 3e opposing each other. The four side surfaces 3a are adjacent to the side surfaces 3e. The four side surfaces 3a and the pair of side surfaces 3e each have a substantially rectangular shape. The four side surfaces 3a include a pair of side surfaces 3a1 opposing each other and a pair of side surfaces 3a2 opposing each other. A direction in which the pair of side surfaces 3a1 oppose each other includes a direction D2. A direction in which the pair of side surfaces 3a2 oppose each other includes a direction D3. A direction in which the pair of side surfaces 3e oppose each other includes a direction D1. For example, the side surface 3e may include a side surface, and the side surface 3a may include an other side surface.

The multilayer capacitor C1 is solder-mounted on an electronic device, for example. The electronic device includes, for example, a circuit board or an electronic component. In the multilayer capacitor C1, for example, one of the four side surfaces 3a opposes the electronic device. The one of the four side surfaces 3a is arranged to constitute a mounting surface. The one of the four side surfaces 3a includes the mounting surface.

The direction D2 includes a direction perpendicular to the pair of side surfaces 3a1, and is perpendicular to the direction D3. The direction D1 includes a direction parallel to the four side surfaces 3a, and is perpendicular to the direction D2 and the direction D3. The direction D3 includes a direction perpendicular to the pair of side surfaces 3a2, and the direction D1 includes a direction perpendicular to the side surfaces 3e. For example, a length of the element body 3 in the direction D1 is larger than a length of the element body 3 in the direction D2 and larger than a length of the element body 3 in the direction D3. The direction D1 includes a longitudinal direction of the element body 3. The length of the element body 3 in the direction D2 and the length of the element body 3 in the direction D3 may be equal to each other. The length of the element body 3 in the direction D2 and the length of the element body 3 in the direction D3 may be different from each other.

The length of the element body 3 in the direction D2 defines, for example, a height of the element body 3. The length of the element body 3 in the direction D3 defines, for example, a width of the element body 3. The length of the element body 3 in the direction D1 defines, for example, a longitudinal length of the element body 3. For example, the height of the element body 3 ranges from 0.1 to 3.2 mm, the width of the element body 3 ranges from 0.1 to 6.3 mm, and the longitudinal length of the element body 3 ranges from 0.2 to 7.5 mm. For example, the height of the element body 3 is 1.25 mm, the width of the element body 3 is 1.25 mm, and the longitudinal length of the element body 3 is 2.0 mm.

The pair of side surfaces 3a1 extend in the direction D3 to couple the pair of side surfaces 3a2 to each other. The pair of side surfaces 3a1 extend in the direction D1. The pair of side surfaces 3a2 extend in the direction D2 to couple the pair of side surfaces 3a1 to each other. The pair of side surfaces 3a2 extend in the direction D1. The pair of side surfaces 3e extend in the direction D2 to couple the pair of side surfaces 3a1 to each other. The pair of side surfaces 3e extend in the direction D3 to couple the pair of side surfaces 3a2 to each other.

The element body 3 includes a ridge portion between the side surface 3e and the side surface 3a and a ridge portion between one of the pair of side surfaces 3a1 and one of the pair of side surfaces 3a2. For example, the ridge portions are rounded to be curved. For example, the element body 3 is subjected to what is called a round chamfering process. The side surface 3e and the side surface 3a are indirectly adjacent to each other with the ridge portion between the side surface 3e and the side surface 3a. The one of the pair of side surfaces 3a1 and the one of the pair of side surfaces 3a2 are indirectly adjacent to each other with the ridge portion between the one of the pair of side surfaces 3a1 and the one of the pair of side surfaces 3a2.

The element body 3 is configured through laminating a plurality of dielectric layers in the direction D2. The element body 3 includes a plurality of laminated dielectric layers. In the element body 3, a lamination direction of the plurality of dielectric layers coincides with the direction D2. Each dielectric layer includes, for example, a sintered body of a ceramic green sheet containing a dielectric material. Examples of the dielectric material include dielectric ceramics. Examples of the dielectric ceramics include BaTiO₃-based, Ba(Ti, Zr)O₃-based, or (Ba, Ca)TiO₃-based dielectric ceramics. In the actual element body 3, each of the dielectric layers is integrated to such an extent that a boundary between the dielectric layers cannot be visually recognized. The element body 3 includes a ceramic element body.

As illustrated in FIGS. 2 and 3, the multilayer capacitor C1 includes a plurality of internal electrodes 7. The plurality of internal electrodes 7 are disposed in the element body 3. Each of the internal electrodes 7 includes an internal conductor. Each of the internal electrodes 7 is made of an electrically conductive material that is commonly used as an internal conductor of a multilayer electronic component. The electrically conductive material includes, for example, a base metal. The electrically conductive material includes, for example, nickel (Ni) or copper (Cu). Each of the internal electrodes 7 is configured as a sintered body of electrically conductive paste containing the electrically conductive material described above. For example, the internal electrodes 7 include nickel.

The plurality of internal electrodes 7 are disposed in different positions (layers) in the direction D2. The plurality of internal electrodes 7 are disposed in the element body 3 to oppose each other in the direction D2 with an interval therebetween. The internal electrodes 7 adjacent to each other in the direction D2 have different polarities from each other. One end 7a of the internal electrode 7 is exposed at a corresponding side surface 3e of the pair of side surfaces 3e. The internal electrode 7 includes the one end 7a exposed at the corresponding side surface 3e. The plurality of internal electrodes 7 include an internal electrode 7 exposed to one side surface 3e of the pair of side surfaces 3e and an internal electrode 7 exposed to another side surface 3e of the pair of side surfaces 3e. The internal electrodes 7 exposed to the one side surface 3e and the internal electrodes 7 exposed to the other side surface 3e are alternately disposed in the direction D2. The plurality of internal electrodes 7 are disposed in the element body 3 to be distributed in the direction D2. Each of the plurality of internal electrodes 7 is positioned in a plane substantially parallel to the pair of side surfaces 3a1. A direction in which the internal electrodes 7 oppose each other is perpendicular to a direction parallel to the pair of side surfaces 3a1.

In a configuration in which the lamination direction of the plurality of dielectric layers includes the direction D3, the plurality of internal electrodes 7 are disposed in different positions (layers) in the direction D3. In a configuration in which the lamination direction of the plurality of dielectric layers includes the direction D3, the internal electrodes 7 exposed to the one side surface 3e and the internal electrodes 7 exposed to the other side surface 3e are alternately disposed in the direction D3. Each of the plurality of internal electrodes 7 is positioned in a plane substantially parallel to the pair of side surfaces 3a2. The internal electrodes 7 oppose each other in the direction D3.

As illustrated in FIG. 1, the pair of external electrodes 5 are disposed at both ends of the element body 3 in the first direction D1. Each external electrode 5 is disposed on a corresponding side surface 3e of the pair of side surfaces 3e. For example, each external electrode 5 is disposed on the four side surfaces 3a and the one side surface 3e. Each external electrode 5 is formed on five surfaces of the four side surfaces 3a and the side surface 3e as well as the above-described ridge portions. Each of the pair of external electrodes 5 entirely covers the one end 7a of a corresponding internal electrode 7 of the plurality of internal electrodes 7. Each of the pair of external electrodes 5 is directly connected to the corresponding internal electrode 7. Each external electrode 5 is electrically connected to the corresponding internal electrode 7.

As illustrated in FIGS. 2 and 3, each of the pair of external electrodes 5 includes an external conductor 6. The external conductor 6 is disposed on the side surface 3e, and includes a region R1, a region R2, and a region R3. The external conductor 6 is comprised of a conductor layer 6a including the region R1, a conductor layer 6b including the region R2, and an intermediate layer 6c including the region R3. That is, the external conductor 6 includes the conductor layer 6a, the conductor layer 6b, and the intermediate layer 6c. The external conductor 6 is connected to the one end 7a of the internal electrode 7. In FIG. 3, the region R2, the base body 3, and the internal electrode 7 are indicated by two-dot chain lines. For example, the region R1 may include a first region, the region R2 may include a second region, and the region R3 may include a third region.

The region R1 is in contact with the element body 3. The region R1 is disposed on the side surface 3e. The region R1 covers the side surface 3e. The region R1 directly covers the side surface 3e and is in direct contact with the side surface 3e. The region R1 is disposed on, for example, the one side surface 3e and the four side surfaces 3a. The region R1 directly covers, for example, a partial region of the side surface 3a. The region R1 is in direct contact with, for example, the partial region of the side surface 3a. The partial region of the side surface 3a covered by the region R1 is positioned closer to the side surface 3e. The side surface 3a is exposed from the region R1 except for the partial region covered by the region R1. The region R1 is disposed, for example, on the ridge portion between the side surface 3e and the side surface 3a. The region R1 is physically and electrically connected to the one end 7a of the corresponding internal electrode 7. The region R1 is directly connected to the one end 7a of the corresponding internal electrode 7. The side surface 3a includes a region not covered by the region R1. The side surface 3a includes a region exposed from the region R1. The region R1 may not be formed on the side surface 3a. The region R1 may not be formed on the side surface 3a, but may be formed on the ridge portion between the side surface 3e and the side surface 3a. The region R1 may not be formed on the side surface 3a and the ridge between the side surface 3e and the side surface 3a. For example, region R1 includes only a sintered metal layer. The sintered metal layer in region R1 includes a first electrically conductive material. The first electrically conductive material includes, for example, a noble metal or a base metal. The noble metal includes Ag. The noble metal may include Au, Pt or Pd. The base metal includes, for example, Cu or Ni.

The region R2 is positioned on the outermost part of the external conductor 6. The region R2 covers a portion of the region R1 positioned on the side surface 3e. The region R2 is disposed, for example, on the region R1 positioned on the one side surface 3e and the four side surfaces 3a. The region R2 directly covers, for example, a partial region of the side surface 3a. The region R2 is, for example, in direct contact with the partial region of the side surface 3a. The partial region of the side surface 3a covered by the region R2 is positioned closer to the side surface 3e. The side surface 3a is exposed from the region R2 except for the partial region covered by the region R2. The region R2 includes a region in direct contact with the region R1.

The side surface 3a includes a region not covered by the region R2. The side surface 3a includes a region exposed from the region R2. The region R2 may not be formed on the side surface 3a. The region R2 may not be formed on the side surface 3a, but may be formed on a portion of the region R1 positioned on the ridge portion between the side surface 3e and the side surface 3a. The region R2 may not be formed on the portion of the region R1 positioned on the side surface 3a and the portion of the region R1 positioned on the ridge portion between the side surface 3e and the side surface 3a. For example, the region R2 includes only a sintered metal layer. The sintered metal layer in region R2 includes a second electrically conductive material. The second electrically conductive material includes, for example, a noble metal or a base metal. The noble metal includes Ag. The noble metal may include Au, Pt or Pd. The base metal includes, for example, Cu or Ni. The second electrically conductive material includes, for example, the same metal as the metal included in the first electrically conductive material.

The region R3 is positioned between the region R1 and the region R2. The region R3 is disposed on the region R1. The region R3 covers the portion of the region R1 positioned on the side surface 3e. The region R3 is disposed, for example, on the region R1 positioned on the one side surface 3e and the four side surfaces 3a. The region R3 directly covers, for example, a partial region of the side surface 3a. The region R3 is, for example, in direct contact with the partial region of the side surface 3a. The partial region of the side surface 3a covered by the region R3 is positioned closer to the side surface 3e. The side surface 3a is exposed from the region R3 except for the partial region covered by the region R3. The region R3 is formed, for example, on the portion of the region R1 positioned on the ridge portion between the side surface 3e and the side surface 3a. The region R3 covers the region R1 with an area equal to or larger than a half of a surface area of the region R1, for example. For example, the region R3 is in direct contact with the region R2. The entire region R3 is covered with the region R2. The region R3 does not cover the entire region R1. The region R1 includes a region covered by the region R3 and a region not covered by the region R3. The region R2 includes a region positioned on the region R1 and a region positioned on the region R3. The region of the region R2 positioned on the region R1 is in contact with the region R1. The region of the region R2 positioned on the region R1 is directly connected to the region R1. The region of the region R2 positioned on the region R3 is in contact with the region R3. The region of the region R2 positioned on the region R3 is directly connected to the region R3. The region R1 may include a portion exposed from the region R3 on the side surface 3a. The region R3 may not be in contact with the side surface 3a.

The region R3 covers the region R1. A coverage ratio of the region R3 can be obtained, for example, as follows.

A photograph including portions of the regions R1 and R3 positioned on the side surface 3e is acquired. The acquired photograph is, for example, a photograph of a cross-section of the regions R1 and R3 when the multilayer capacitor C1 is cut along a plane perpendicular to the side surface 3e. A photograph including portions of the regions R1 and R3 positioned on the side surface 3a is acquired. The acquired photograph is, for example, a photograph of a cross-section of the regions R1 and R3 when the multilayer capacitor C1 is cut along a plane perpendicular to the side surface 3a. Image processing of the acquired photographs is performed using software. Based on the result of this image processing, a boundary of the region R1 and a boundary of the region R3 are determined, and a length L1 of a portion where the region R1 is in contact with the region R2 and a length L3 of a portion where the region R3 is in contact with the region R1 in the photographs are obtained. The lengths L1 and L3 are, for example, average values obtained through averaging the lengths obtained in a plurality of acquired photographs. The coverage ratio is a value calculated by L3/(L1+L3).

The region R3 includes, for example, a portion R3a that exposes the region R1. The portion R3a has, for example, the shape of an opening. The region R3 does not cover the region R1 in the portion R3a. The regions R1 and R2 may be directly connected to each other through the portion R3a, for example. The region R3 may include a plurality of the portions R3a. The region R3 may not include the portion R3a.

The region R3 has a thickness of, for example, 1 μm or more. The thickness of the region R3 is obtained, for example, as follows.

A cross-sectional photograph of the multilayer capacitor C1 at a position including the region R3 is acquired. The cross-sectional photograph of the region R3 positioned on the side surface 3e is, for example, a photograph of a cross-section of the region R3 when the multilayer capacitor C1 is cut along a plane perpendicular to the side surface 3e. The cross-sectional photograph of the region R3 positioned on the side surface 3a1 is, for example, a photograph of a cross-section of the region R3 when the multilayer capacitor C1 is cut along a plane perpendicular to the side surface 3a1. The cross-sectional photograph of the region R3 positioned on the side surface 3a2 is, for example, a photograph of a cross-section of the region R3 when the multilayer capacitor C1 is cut along a plane orthogonal to the side surface 3a2. The cross-sectional photograph is, for example, an SEM (scanning electron microscope) photograph. The SEM photograph includes, for example, a composition-image photograph. Image processing of the acquired cross-sectional photograph is performed using software. Based on the result of this image processing, a boundary of the region R3 is determined, and the thickness of the region R3 is obtained. The thickness of the region R3 is, for example, an average value obtained through averaging the thicknesses obtained in the acquired cross-sectional photograph.

The region R3 includes a material that is less permeable to hydrogen than each of regions R1 and R2. The region R3 has a hydrogen content ratio smaller than a hydrogen content ratio of each of the regions R1 and R2. The hydrogen content ratio serves as an index indicating the ease with which hydrogen is retained. The region with a small hydrogen content ratio tends not to retain hydrogen, and the amount of hydrogen passing through this region is small. Therefore, the region R3 tends to retain less hydrogen and to be less permeable to hydrogen than the regions R1 and R2. The region R3 has a hydrogen permeability coefficient smaller than that of each of the regions R1 and R2. The hydrogen permeability coefficient serves as an index indicating the barrier property against hydrogen. The region with a small hydrogen permeability coefficient exhibits high barrier property against hydrogen, and the amount of hydrogen passing through this region is small. Therefore, Hydrogen tends not to pass through the region R3 as compared with the regions R1 and R2. The region R3 includes a material having the hydrogen permeability coefficient smaller than the hydrogen permeability coefficients of the first and second electrically conductive materials included in the regions R1 and R2.

The above-described material included in the region R3 includes glass having a hydrogen permeability coefficient smaller than that of the first and second electrically conductive materials. The glass includes, for example, a network-forming oxide or a network-modifying oxide. The network-forming oxides include, for example, silicon dioxide, aluminum oxide, or diboron trioxide. The network-modifying oxides include, for example, alkali metal oxide, alkaline earth metal oxide, or zinc oxide. The network-forming oxide includes, for example, 16.1Na₂O-16.1Al₂O₃-67.8SiO₂. The coefficients for each component represent mol %. The hydrogen permeability coefficient of 16.1Na₂O-16.1Al₂O₃-67.8SiO₂ at a temperature of 398 K is 1×10⁻²⁰ mol-H₂/(m·s·Pa^{1/2}). This hydrogen permeability coefficient is 1×10⁻¹⁵ mol-H₂/(m·s) at a pressure of 1 atm.

The hydrogen permeability coefficient of Cu at a temperature of 398 K is 4.03×10⁻¹⁷ mol-H₂/(m·s·Pa^{1/2}). This hydrogen permeability coefficient is 1.27×10⁻¹⁴ mol-H₂/(m·s) at a pressure of 1 atm. The above-described glass has the hydrogen permeability coefficient that is smaller than that of Cu under a pressure of 1 atm.

The region R3 may include resin. The resin may include, for example, an epoxy resin, a phenolic resin, or an unsaturated polyester resin. Hydrogen is present in the form of a gas in the resin. Hydrogen is present in the metal included in region R2 in the form of an atom, dissolved as a solid solution in the metal. Therefore, in order for hydrogen to diffuse from the region R2 to the region R3, it is necessary that the dissolved hydrogen is converted into hydrogen gas at the interface between the region R2 and the region R3. The activation energy required to convert the dissolved hydrogen into hydrogen gas suppresses hydrogen from diffusing into region R3. Consequently, the region R3 suppresses hydrogen from permeating through the external conductor.

The multilayer capacitor C1 includes a plating layer 9 formed on the external conductor 6. The plating layer 9 includes a metal plating layer. The metal plating layer has, for example, a multilayer structure. For example, the plating layer 9 is comprised of a first layer 9a and a second layer 9b. The first layer 9a includes, for example, a Ni plating layer. The first layer 9a may include a Sn plating layer, a Cu plating layer, or an Au plating layer. The second layer 9b includes, for example, a solder plating layer. The solder plating layer includes, for example, a Sn plating layer. The second layer 9b may include a Sn—Ag alloy plating layer, a Sn—Bi alloy plating layer, or a Sn—Cu alloy plating layer. The first layer 9a covers the region R2. The first layer 9a is directly connected to the region R2. The second layer 9b covers the first layer 9a. In FIG. 3, the plating layer is omitted from the illustration.

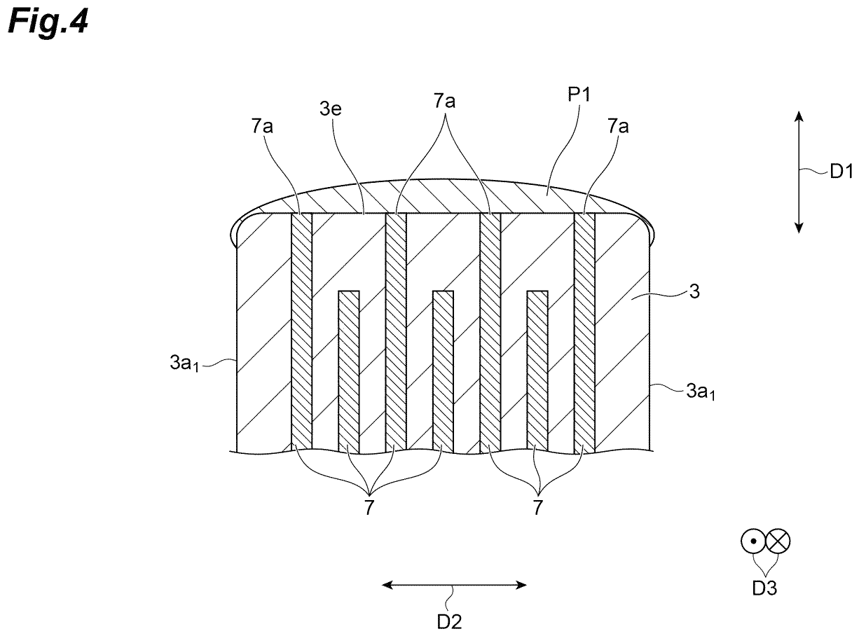

A process for forming the external conductor 6 in the present example will be described below with reference to FIGS. 4 to 6. FIGS. 4 to 6 are diagrams illustrating an example of the process for forming the external conductor. The process for forming the external conductor 6 includes: applying a first paste P1 to the element body 3; sintering the first paste P1 to form regions R1 and R3; applying a second paste P2 on the region R3; and sintering the second paste P2 to form the region R2.

As illustrated in FIG. 4, in the process for forming the external conductor 6, the first paste P1 is applied on the side surfaces 3e and 3a of the element body 3. The first paste P1 includes a conductive paste, and the conductive paste includes a metal component, a glass component, an organic binder, and an organic solvent. The metal component includes a metal powder. The metal powder includes a metal powder of a noble metal or a metal powder of a base metal. The noble metal includes Ag. The noble metal may include Au, Pt, or Pd. The base metal may include Cu or Ni. The first paste P1 includes, for example, Cu powder, glass frit, the organic binder, and the organic solvent.

Next, the first paste P1 applied to the side surfaces 3e and 3a is sintered. For example, the sintering temperature ranges from 700° C. to 800° C.

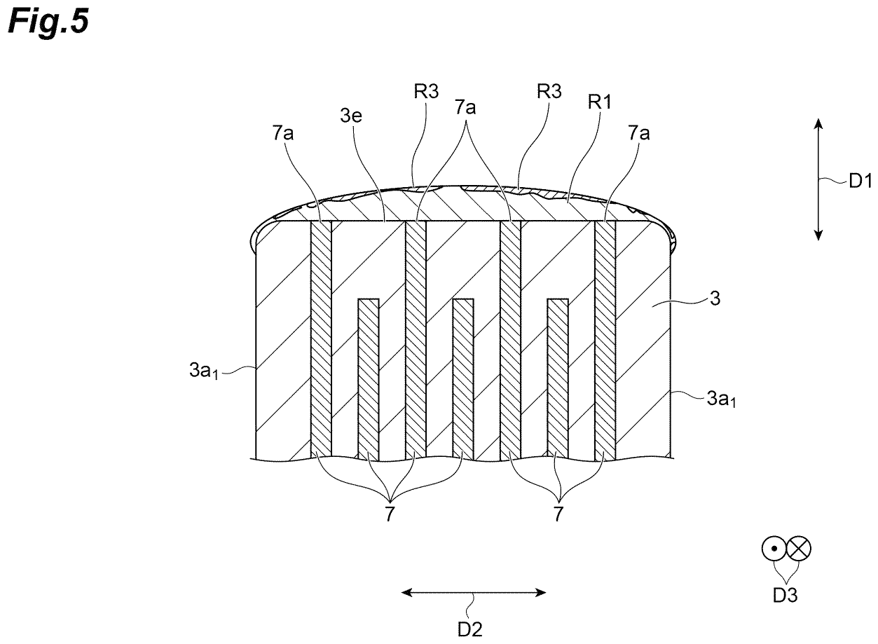

As illustrated in FIG. 5, The region R1 and the region R3 are formed through sintering the first paste P1. The region R1 includes the sintered metal layer. The sintered metal layer includes a layer in which metal powder included in the first paste P1 is sintered. The metal powder includes Ag or Cu. During sintering the first paste P1, the glass component included in the first paste P1 migrates onto the surface of the first paste P1. The glass component migrated onto the surface of the first paste P1 forms the region R3. The region R1 is formed on the element body 3, and the region R3 is formed on the region R1. The region R3 includes a larger amount of glass component than the glass component included in the region R1. The region R3 is formed in the applied first paste P1. The region R1 covers the one end 7a of the internal electrode 7. The region R3 covers the region R1 positioned on the side surface 3e.

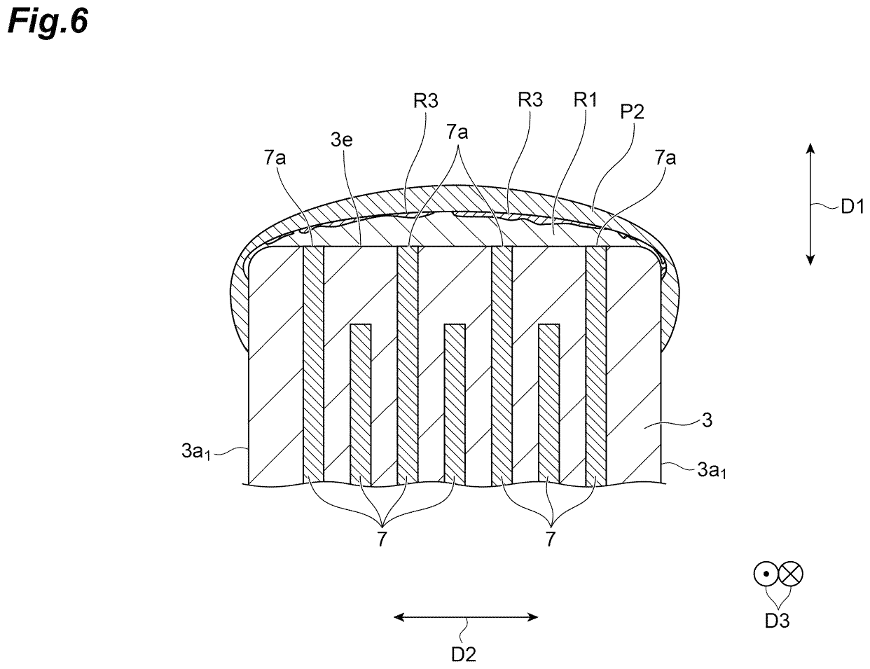

Next, as illustrated in FIG. 6, the second paste P2 is applied so as to cover the regions R1 and R3. The second paste P2 includes a metal component, a glass component, an organic binder, and an organic solvent. The second paste P2 includes, for example, the same metal powder, glass component, organic binder, and organic solvent as the first paste P1. The second paste P2 includes, for example, the Cu powder, the glass frit, the organic binder, and the organic solvent.

Next, the applied second paste P2 is sintered. For example, the temperature at which the second paste P2 is sintered ranges from 700° C. to 800° C. The region R2 is formed through sintering the second paste P2. The region R2 covers the entire region R3. Through forming the region R2, the external conductor 6 is formed. The second paste P2 has a glass content smaller than a glass content of the first paste P1. Therefore, the conductor layer 6b including the region R2 has a glass content smaller than a glass content of the conductor layer 6a including the region R1.

Next, the plating layer 9 is formed on the region R2. On the region R2, the Ni plating layer is formed as the first layer 9a, and on the Ni plating layer, the Sn plating layer is formed as the second layer 9b. The plating layer 9 is formed through a plating process. The plating process includes, for example, an electroplating process.

The materials included in the first paste P1 and the content (weight percent) of each material are exemplified as follows.
Metal powder (Cu powder): 60 wt %
Glass component (glass frit): 25 wt %
Organic substances (organic binder and organic solvent): 15 wt %

The materials included in the second paste P2 and the content (weight percent) of each material are exemplified as follows.
Metal powder (Cu powder): 75 wt %
Glass component (glass frit): 5 wt %
Organic substances (organic binder and organic solvent): 20 wt %

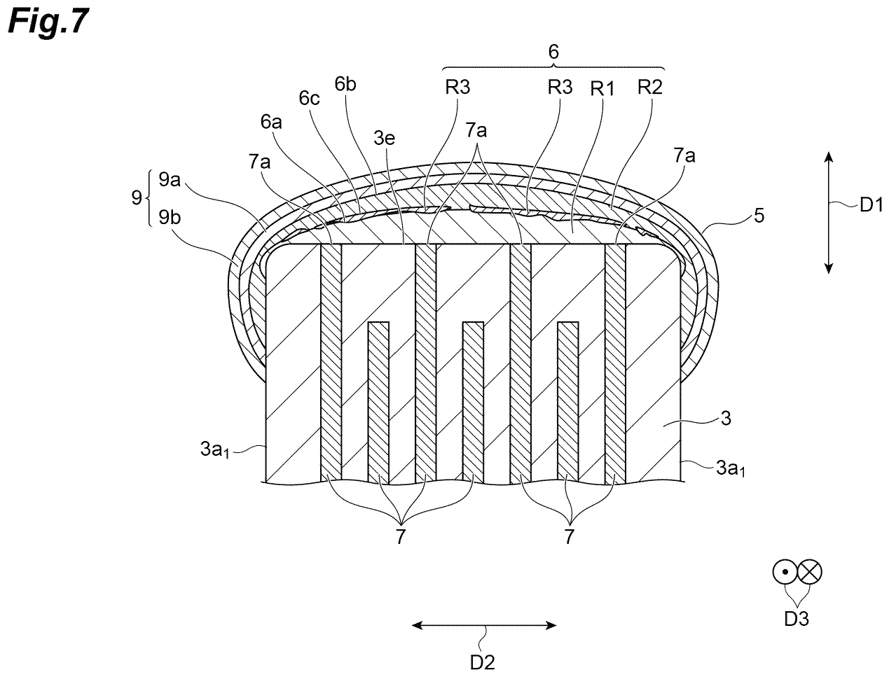

A multilayer capacitor C1 according to a modification of the present example will be described with reference to FIG. 7. FIG. 7 is a view illustrating a cross-sectional configuration of a multilayer capacitor according to the modification of the example. The multilayer capacitor C1 according to the modification includes the element body 3, the external conductor 6, and the internal electrode 7 (internal conductor). The external conductor 6 includes the regions R1, R3, and R2. The multilayer capacitor C1 according to the modification is different from the multilayer capacitor C1 according to the present example in the process for forming the external conductor 6.

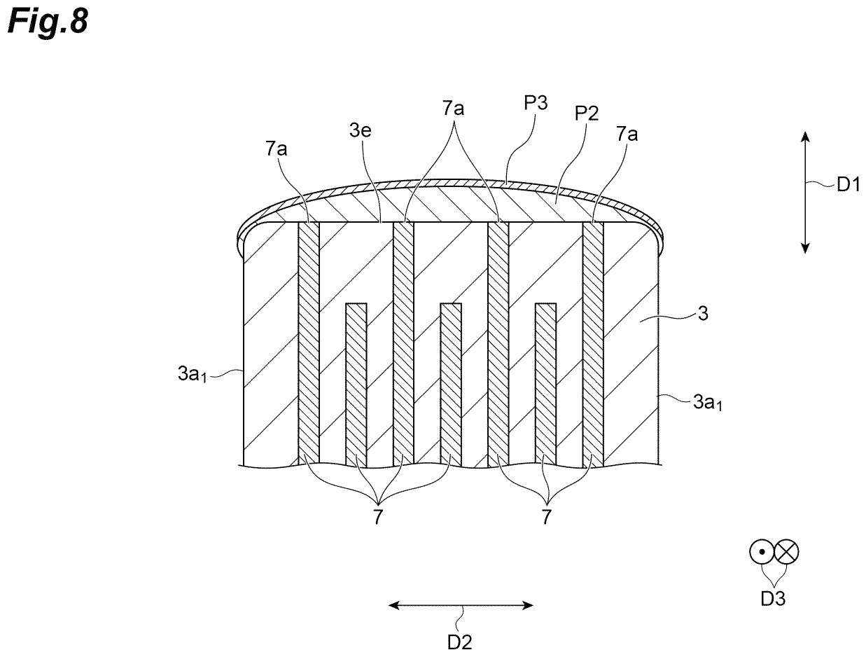

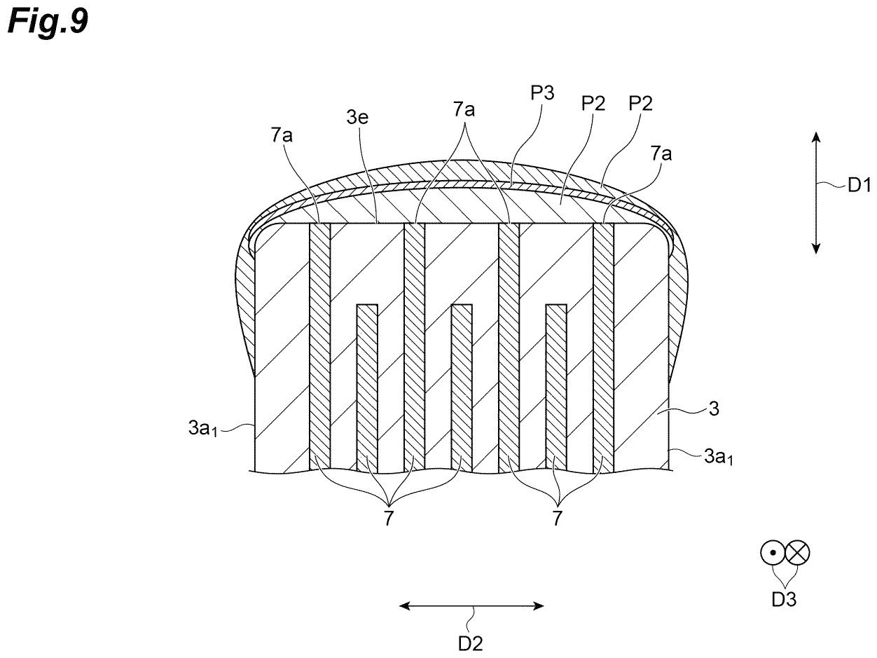

A process for forming the external conductor 6 according to the modification will be described with reference to FIGS. 8 and 9. FIGS. 8 and 9 are diagrams illustrated an example of the process for forming the external conductor. The process for forming an external conductor 6 includes: applying the second paste P2 to the element body 3; applying a third paste P3 on the second paste P2; applying another second paste P2 so as to cover the second paste P2 and the third paste P3; and sintering the second paste P2, the third paste P3, and the other second paste P2, thereby forming the regions R1, R3, and R2.

As illustrated in FIG. 8, in the process for forming the external conductor 6 according to the modification, the second paste P2 is applied on the side surfaces 3e and 3a. Next, the third paste P3 is applied on the second paste P2. The third paste P3 includes a glass component, an organic binder, and an organic solvent. The third paste P3 is applied, for example, through a screen-printing process. The third paste P3 includes a larger amount of glass component than the glass component included in the second paste P2. The third paste P3 has a glass content larger than the glass content of the second paste P2.

Next, as illustrated in FIG. 9, the other second paste P2 is applied so as to cover the second paste P2 and the third paste P3 applied on the side surfaces 3e and 3a. For example, the other second paste P2 includes the same metal powder, glass component, organic binder, and organic solvent as the second paste P2.

Next, the second paste P2, the third paste P3, and the other second paste P2 are sintered to form the regions R1, R3, and R2. The second paste P2 forms the region R1, the third paste P3 forms the region R3, and the other second paste P2 forms the region R2. For example, the temperature at which the second and third pastes P2 and P3 are sintered ranges from 700° C. to 850° C. The external conductor 6 is formed through forming the regions R1, R3, and R2. The region R1 is formed in the applied second paste P2. The region R3 is formed in the applied third paste P3. The region R2 is formed in the other applied second paste P2. The region R1 covers the entire side surface 3e and the one end 7a of the internal electrode 7. The region R3 covers the region R1 positioned on the side surface 3e, with an area that is at least half of the surface area of the region R1 positioned on the side surface 3e. The region R2 covers the entire region R3.

The materials included in the third paste P3 and the content (weight percent) of each material are exemplified as follows.
Glass component (glass frit): 80 wt %
Organic substances (organic binder and organic solvent): 20 wt %

In the process for forming the external conductor 6 according to the modification, the plating layer 9 is formed on the region R2 in the same manner as in the above process for forming the external conductor 6. The plating layer 9 is comprised of the Ni plating layer as the first layer 9a and the Sn plating layer as the second layer 9b.

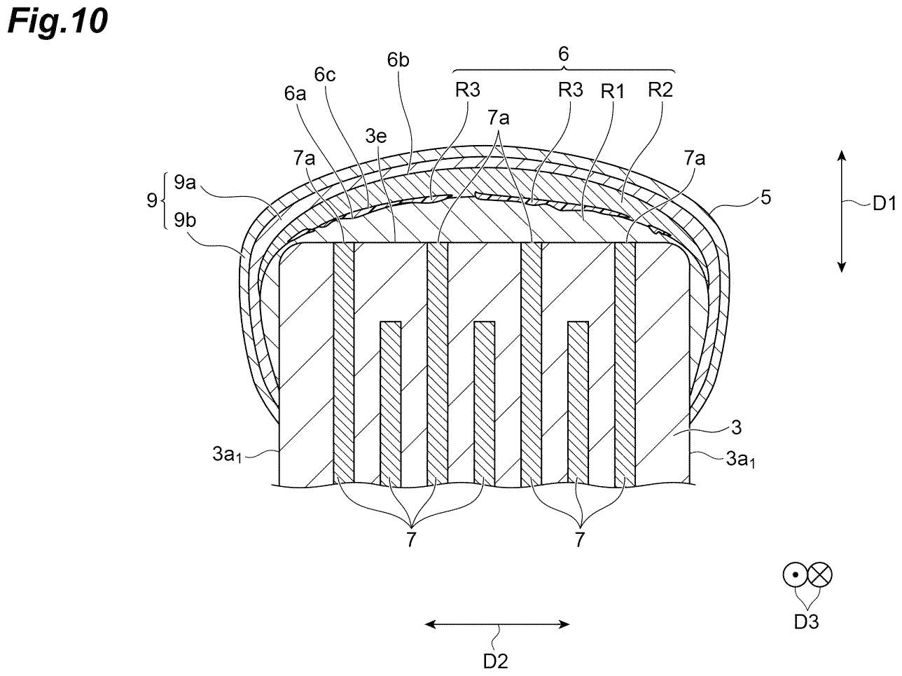

A multilayer capacitor C1 according to another modification of the present example will be described with reference to FIG. 10. FIG. 10 is a view illustrating a cross-sectional configuration of a multilayer capacitor according to another modification of the example. The multilayer capacitor C1 according to the other modification includes the element body 3, the external conductor 6, and the internal electrode 7 (internal conductor). The external conductor 6 includes the regions R1, R3, and R2. In the multilayer capacitor C1 according to the other modification, the process for forming the external conductor 6 is different from that in the multilayer capacitor C1 according to the example.

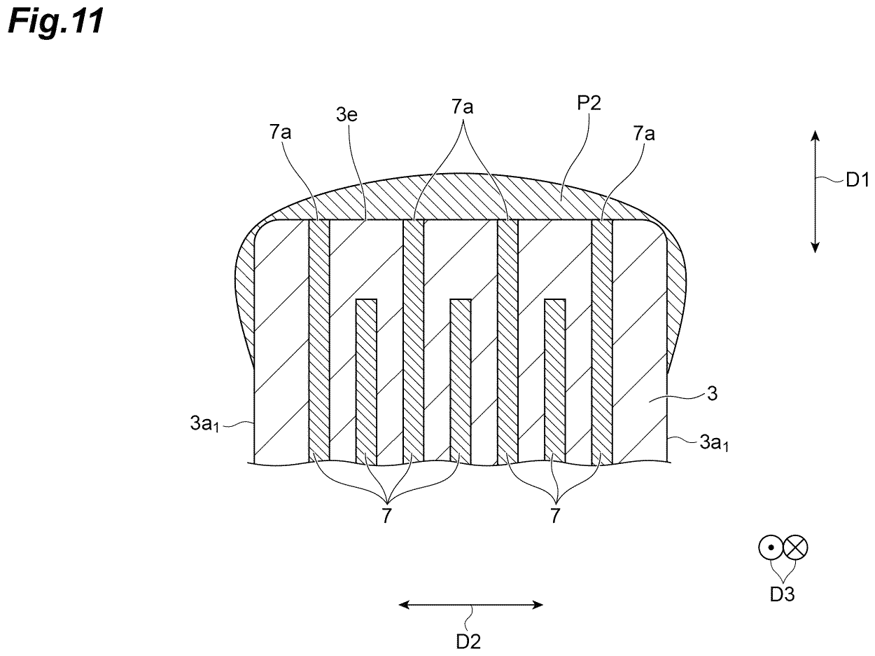

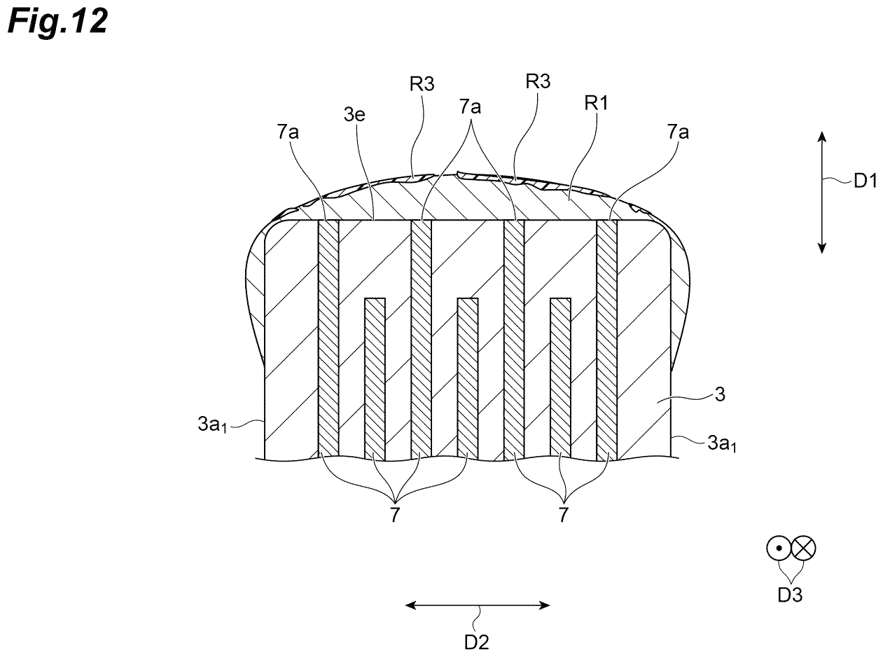

A process for forming the external conductor 6 according to the other modification will be described with reference to FIGS. 11 and 12. FIGS. 11 and 12 are diagrams illustrating an example of a process for forming the external conductor. The process for forming the external conductor 6 according to the other modification includes: applying the second paste P2 to the element body 3; sintering the applied second paste P2; applying resin on the sintered second paste P2, curing the applied resin; forming a metal layer on the cured resin, thereby forming the regions R1, R3, and R2.

As illustrated in FIG. 11, in the process for forming the external conductor 6 according to the other modification, the second paste P2 is applied on the side surfaces 3e and 3a. The second paste P2 applied on the side surfaces 3e and 3a is sintered. For example, the sintering temperature ranges from 700° C. to 850° C. The region R1 is formed through sintering the second paste P2. The region R1 is formed in the applied second paste P2. The formed region R1 covers the entire side surface 3e and covers the one end 7a of the internal electrode 7.

Next, the resin is applied on the region R1 formed from the second paste P2. For example, the resin is applied through a screen-printing process. The resin includes, for example, an epoxy resin.

Next, as illustrated in FIG. 12, the applied resin is cured. For example, the resin is cured through heat treatment at a temperature of 200° C. for 30 minutes. The cured resin forms the region R3. The region R3 is formed of the resin. The region R3 covers the region R1 positioned on the side surface 3e, with an area that is at least half of the surface area of the region R1 positioned on the side surface 3e.

In the other modification, next, a metal layer is formed to cover the regions R1 and R3. For example, the metal layer is formed through a sputtering process. The metal layer includes, for example, a Cu film. The metal layer forms the region R2. The metal layer covers the entire cured resin. The external conductor 6 is formed through forming the regions R1, R3, and R2.

In the process for forming the external conductor 6 according to the other modification, the plating layer 9 is formed on the region R2 in the same manner as in the above process for forming the external conductor 6. The plating layer 9 is comprised of the Ni plating layer as the first layer 9a and the Sn plating layer as the second layer 9b.

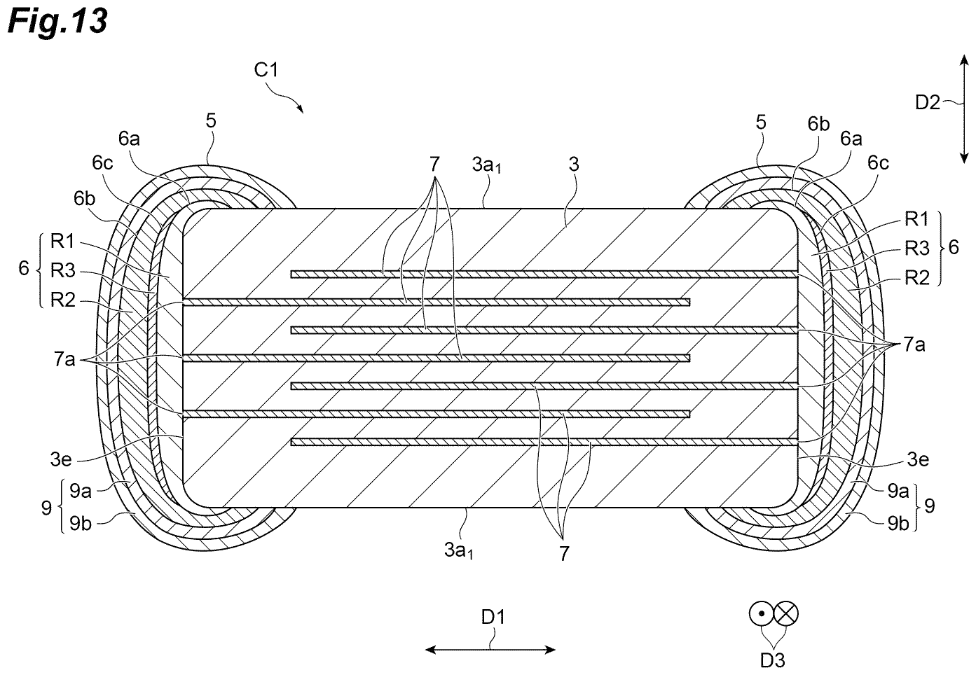

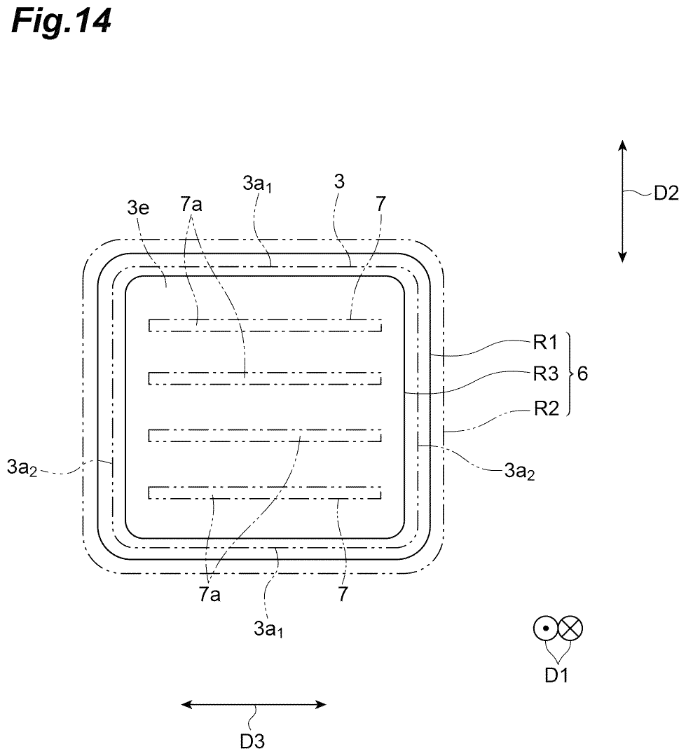

A multilayer capacitor C1 according to a still another modification of the present example will be described with reference to FIGS. 13 and 14. FIG. 13 is a view illustrating a cross-sectional configuration of a multilayer capacitor according to a still another modification of the example. FIG. 14 is a view illustrating an external conductor. The multilayer capacitor C1 according to the still another modification includes the element body 3, the external conductor 6, and the internal electrode 7 (internal conductor). The external conductor 6 includes the regions R1, R3, and R2. In FIG. 14, the plating layer 9 is omitted from the illustration, and the region R2, the element body 3, and the internal electrode 7 are illustrated by two dot chain lines.

The multilayer capacitor C1 according to the still another modification differs from the multilayer capacitors C1 according to the present example and the multilayer capacitors C1 according to the modification and the other modification of the present example in the shape of the external conductor 6. In the still another modification, the portion R3a that exposes the region R1 is not formed in the region R3. The region R3 covers the region R1 without the portion R3a being formed. The entire region R3 covers the region R1. For example, the portion of the region R1 that is exposed from the region R3 includes only a portion of the region R1 that is positioned along the outer edge of the region R3. In the still another modification, the region R3 covers the region R1 with the area equal to or larger than a half of the surface area of the region R1. The region R2 is positioned on the outermost part of the external conductor 6, and is disposed on the region R3.

The present inventors conducted an insulation resistance test and a simulation in order to clarify the hydrogen diffusion inhibition characteristics and the electrical conductivity characteristics of the multilayer capacitor C1 according to the present example. The present inventors conducted the insulation resistance test and the simulation to determine the amount of hydrogen diffusion using the finite element method in order to clarify the hydrogen diffusion inhibition characteristics. The present inventors performed a correlation between the results of the insulation resistance test, that is, the measurement results of insulation resistance values, and the simulation results for determining the amount of hydrogen diffusion. Based on the results of this correlation, the present inventors evaluated the hydrogen diffusion inhibition characteristics. The present inventors conducted the simulation to determine the electrical conductivity of the external conductor using the finite element method in order to clarify the electrical conductivity characteristics.

In the insulation resistance test, for example, a measurement system including a measurement substrate, a thermostatic chamber, an electric power supply, a resister, and an electric voltmeter is used. In the measurement system, a sample is mounted on the measurement substrate. The sample mounted on the measurement substrate is heated in the thermostatic chamber that is maintained at a temperature of 125° C. A predetermined electric voltage is continuously applied from the electric power supply to the sample during the sample being heated in the thermostatic chamber. The resistor and the electric voltmeter are connected in parallel, and the resistor and the electric voltmeter connected in parallel are connected in series to the sample and the electric power supply. When the predetermined electric voltage is applied to the sample, the electric voltage across the resistor is measured by the electric voltmeter. The electric current flowing through the resistor is obtained based on the electric voltage across the resistor. Based on the electric current flowing through the resistor, the electric leakage current generated in the sample, i.e., the electric leakage current value is obtained. The insulation resistance value of the sample is experimentally determined based on the electric leakage current value and the value of the predetermined electric voltage. The insulation resistance value corresponds to the magnitude of resistance of the multilayer capacitor to the electric leakage current. The electric leakage current value is measured at predetermined time intervals. The predetermined time interval is set to one hour. The predetermined electric voltage is set to 6.3 V. The maximum heating time for the sample in the thermostatic chamber is set to 100 hours. The sample includes the region R3 including the glass in the material. The multilayer capacitor C1 used in the test has a 2012 size according to JIS standard, for example. The 2012 size according to JIS standard corresponds to the 0805 size according to the EIA standard. The capacitance of the sample including the multilayer capacitor C1 used in the test is 4.7 μF.

In the insulation resistance test, a plurality of samples are prepared. In each sample, the thickness of region R3 is set to 10 μm, and the coverage ratio of the region R3 is set to 90%. The insulation resistance test is performed on an arbitrary number of samples taken from among the plurality of samples. The above-described arbitrary number is set to, for example, fifty.

In the finite element method used to clarify the hydrogen diffusion inhibition characteristics, an analysis region is defined with a geometry that reproduces the measurement system of the above-described insulation resistance test. The geometry includes, for example, the configuration, capacity, and electrical connections of each element corresponding to the sample, the measurement substrate, the thermostatic chamber, the electric power supply, and the electric voltmeter. The analysis region is set so that each of these elements is included as an object of analysis.

A simulation is conducted to determine the amount of hydrogen diffusion at a temperature of 125° C., under varying thicknesses and coverage ratios of the region R3. Three thicknesses are set for region R3: 1 μm, 3 μm, and 10 μm. Eight coverage ratios are set for region R3: 20%, 40%, 50%, 60%, 70%, 80%, 90%, and 95%. In the simulation, a total of 24 combinations of these thicknesses and coverage ratios are evaluated. The simulation results for the amount of hydrogen diffusion reveal the hydrogen diffusion inhibition characteristics. The hydrogen diffusion inhibition characteristics are determined based on the heating time required for the hydrogen concentration in the Ni included in the internal conductor to exceed the threshold value.

Hydrogen exists in the metals included in the external electrode and the internal conductor in the state of hydrogen atoms dissolved in the metals. Since it is difficult to directly determine the concentration of hydrogen atoms dissolved in the metal, the hydrogen concentration in the metal is defined based on the pressure of hydrogen gas that is in equilibrium with the hydrogen atoms in the metal, that is, the equilibrium hydrogen partial pressure. When hydrogen gas at a pressure of 1 atmosphere and a temperature of 25° C. is in equilibrium with hydrogen atoms in Ni, the hydrogen concentration in Ni is defined as 1.

In the simulation, the following process is calculated. This process includes heating the sample mounted on the measurement substrate in the thermostatic chamber, and diffusing hydrogen atoms included in the Ni of the first layer 9a into the Ni of the internal conductor so that the hydrogen atoms in the Ni of the first layer 9a migrate into the Ni of the internal conductor through the regions R1, R3, and R2. In the simulation, based on the results of the above insulation resistance test, 0.013 is used as the threshold value for the hydrogen concentration in the Ni included in the internal conductor.

The finite element method used to clarify the electrical conductivity characteristics is set up in the same manner as the above-described simulation for determining the amount of hydrogen diffusion, and a simulation for determining the electrical conductivity of the external conductor is conducted. Simulations are conducted for the electrical conductivity of the external conductor including the region R3 and for the electrical conductivity of the external conductor not including the region R3. Based on the results of the simulations, the magnitude of the electrical conductivity of the external conductor is calculated. The ratio of the magnitude of the electrical conductivity of the external conductor including the region R3 to the magnitude of the electrical conductivity of the external conductor not including the region R3 is defined as the electrical conductivity characteristic of the sample. The electrical conductivity characteristic is determined based on the amount of change in the value of electrical resistance calculated from the magnitude of the electrical conductivity.

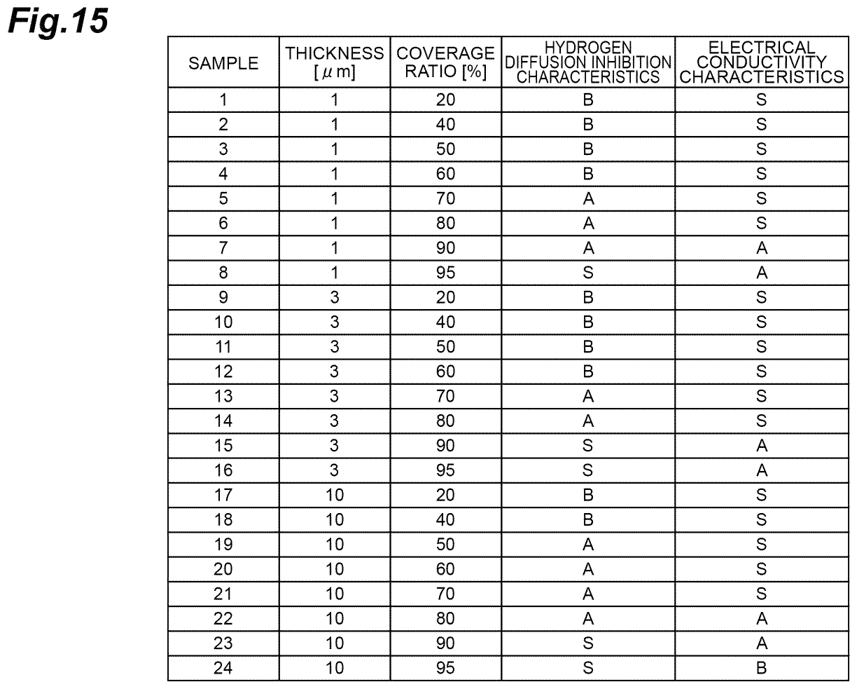

FIG. 15 is a table illustrating the hydrogen diffusion inhibition characteristics and the electrical conductivity characteristics of the multilayer capacitor C1 according to the present example. In the simulation, samples 1 to 24 are set such that the thickness and the coverage ratio of the region R3 are varied.

In sample 1, the thickness of the region R3 is 1 μm, and the coverage ratio of the region R3 is 20%.

In sample 2, the thickness of the region R3 is 1 μm, and the coverage ratio of the region R3 is 40%.

In sample 3, the thickness of the region R3 is 1 μm, and the coverage ratio of the region R3 is 50%.

In sample 4, the thickness of the region R3 is 1 μm, and the coverage ratio of the region R3 is 60%.

In sample 5, the thickness of the region R3 is 1 μm, and the coverage ratio of the region R3 is 70%.

In sample 6, the thickness of the region R3 is 1 μm, and the coverage ratio of the region R3 is 80%.

In sample 7, the thickness of the region R3 is 1 μm, and the coverage ratio of the region R3 is 90%.

In sample 8, the thickness of the region R3 is 1 μm, and the coverage ratio of the region R3 is 95%.

In sample 9, the thickness of the region R3 is 3 μm, and the coverage ratio of the region R3 is 20%.

In sample 10, the thickness of the region R3 is 3 μm, and the coverage ratio of the region R3 is 40%.

In sample 11, the thickness of the region R3 is 3 μm, and the coverage ratio of the region R3 is 50%.

In sample 12, the thickness of the region R3 is 3 μm, and the coverage ratio of the region R3 is 60%.

In sample 13, the thickness of the region R3 is 3 μm, and the coverage ratio of the region R3 is 70%.

In sample 14, the thickness of the region R3 is 3 μm, and the coverage ratio of the region R3 is 80%.

In sample 15, the thickness of the region R3 is 3 μm, and the coverage ratio of the region R3 is 90%.

In sample 16, the thickness of the region R3 is 3 μm, and the coverage ratio of the region R3 is 95%.

In sample 17, the thickness of the region R3 is 10 μm, and the coverage ratio of the region R3 is 20%.

In sample 18, the thickness of the region R3 is 10 μm, and the coverage ratio of the region R3 is 40%.

In sample 19, the thickness of the region R3 is 10 μm, and the coverage ratio of the region R3 is 50%.

In sample 20, the thickness of the region R3 is 10 μm, and the coverage ratio of the region R3 is 60%.

In sample 21, the thickness of the region R3 is 10 μm, and the coverage ratio of the region R3 is 70%.

In sample 22, the thickness of the region R3 is 10 μm, and the coverage ratio of the region R3 is 80%.

In sample 23, the thickness of the region R3 is 10 μm, and the coverage ratio of the region R3 is 90%.

In sample 24, the thickness of the region R3 is 10 μm, and the coverage ratio of the region R3 is 95%.

### [Hydrogen Diffusion Inhibition Characteristics]

In the evaluation of the hydrogen diffusion inhibition characteristics, the following criteria are used.

Evaluation “S”: Even after a heating time of 100 hours or more, the insulation resistance value does not change compared to before heating, and the hydrogen concentration does not exceed the threshold.

Evaluation “A”: After a heating time of 10 hours or more but less than 100 hours, the insulation resistance value changes by 50% or more compared to before heating, and the hydrogen concentration does not exceed the threshold.

Evaluation “B”: After a heating time of less than 10 hours, the insulation resistance value changes by 50% or more compared to before heating, and the hydrogen concentration exceeds the threshold.

From the perspective of the hydrogen diffusion inhibition characteristics, configurations that have been given an evaluation of “S” or “A” tend to particularly suppress the deterioration of the characteristics of the multilayer capacitor C1. Configurations that have been given an evaluation of “B” tend to suppress the deterioration of the characteristics of the multilayer capacitor C1.

The evaluation criteria for Samples 1 to 8 are as follows.
Configuration with the coverage ratio of 20-60%:Evaluation “B”
Configuration with the coverage ratio of 70-90%:Evaluation “A”
Configuration with the coverage ratio of 95%:Evaluation “S”

The evaluation criteria for Samples 9 to 16 are as follows.
Configuration with the coverage ratio of 20-60%:Evaluation “B”
Configuration with the coverage ratio of 70-80%:Evaluation “A”
Configuration with the coverage ratio of 90-95%:Evaluation “S”

The evaluation criteria for Samples 17 to 24 are as follows.
Configuration with the coverage ratio of 20-40%:Evaluation “B”
Configuration with the coverage ratio of 50-80%:Evaluation “A”
Configuration with the coverage ratio of 90-95%:Evaluation “S”

Based on the evaluation results of the hydrogen diffusion inhibition characteristics, in a configuration in which the coverage ratio of the region R3 ranges from 70% to 80%, it was found that the multilayer capacitor C1 in which the thickness of the region R3 is 1 μm or 3 μm tends to suppress the deterioration of the hydrogen diffusion inhibition characteristics. In a configuration in which the coverage ratio of the region R3 is 50% or higher, the multilayer capacitor C1 in which the thickness of the region R3 is 10 μm tends to suppress the deterioration of the hydrogen diffusion inhibition characteristics.

### [Electrical Conductivity Characteristics]

In the evaluation of the electrical conductivity characteristics, the following criteria are used.
Evaluation “S”: The electrical resistance value is less than three times that of an external conductor not including the region R3.
Evaluation “A”: The electrical resistance value is three times or more and less than ten times that of an external conductor not including the region R3.
Evaluation “B”: The electrical resistance value is ten times or more that of an external conductor not including the region R3.

From the perspective of the electrical conductivity characteristics, configurations that have been assigned an evaluation of “S” or “A” tend to suppress further the deterioration of the characteristics of the multilayer capacitor C1. Configurations that have been also assigned an evaluation of “B” tend to suppress the deterioration of the characteristics of the multilayer capacitor C1.

The evaluation criteria for Samples 1 to 8 are as follows.
Configuration with the coverage ratio of 20-80%:Evaluation “S”
Configuration with the coverage ratio of 90-95%:Evaluation “A”

The evaluation criteria for Samples 9 to 16 are as follows.
Configuration with the coverage ratio of 20-80%:Evaluation “S”
Configuration with the coverage ratio of 90-95%:Evaluation “A”

The evaluation criteria for Samples 17 to 24 are as follows.
Configuration with the coverage ratio of 20-70%:Evaluation “S”
Configuration with the coverage ratio of 80-90%:Evaluation “A”
Configuration with the coverage ratio of 95%: Evaluation “B”

Based on the evaluation results of the electrical conductivity characteristics, in a configuration in which the coverage ratio ranges from 20% to 90%, it was found that the multilayer capacitor C1 in which the thickness of the region R3 is 1 μm, 3 μm, or 10 μm tends to suppress the deterioration of the electrical conductivity characteristics.

In the evaluation of the hydrogen diffusion inhibition properties and the electrical conductivity properties, in a configuration in which the region R3 includes the glass, equivalent evaluation results are obtained regardless of the kind of glass included in the region R3. In a configuration in which the region R3 includes the resin, as long as the resin exhibits the hydrogen diffusion inhibition properties equivalent to those of the glass, results comparable to the evaluation of the hydrogen diffusion inhibition properties and the electrical conductivity properties in the glass-including configuration of the region R3 can be obtained. For example, the resin contained in the region R3 includes an epoxy resin.

Based on the evaluation results of the hydrogen diffusion inhibition properties and the electrical conductivity properties, the following findings were obtained.

The configurations in which the thickness of the region R3 is 1 μm, 3 μm, or 10 μm tend to particularly suppress the deterioration of the above two characteristics. That is, the configurations in which the thickness of the region R3 is 1 μm or greater also tend to suppress the deterioration of the above two characteristics. Even configurations in which the thickness of the region R3 is less than 1 μm tend to suppress the deterioration of the above two characteristics.

The configuration in which the coverage ratio of the region R3 relative to the region R1 ranges from 50% to 90% tends to particularly suppress the deterioration of the above two characteristics. That is, the configurations in which the coverage ratio of the region R3 is 50% or more tend to suppress the deterioration of the above two characteristics. The configuration in which the coverage ratio of the region R3 relative to the region R1 ranges from 70% to 80% tends to suppress the deterioration of the above two characteristics regardless of whether the thickness of the region R3 is 1 μm, 3 μm, or 10 μm.

The configuration in which the coverage ratio of the region R3 relative to the region R1 ranges from 70% to 80%, and the thickness of the region R3 ranges from 1 μm to 3 μm tends to particularly suppress the deterioration of the above two characteristics. The multilayer capacitor C1 including the region R3 tends to suppress the deterioration of the above two characteristics regardless of the coverage ratio of the region R3 relative to region R1.

The thickness “T” (μm) of the region R3 and the coverage ratio “C” (%) of the region R3 relative to the surface of the region R1 are found to satisfy a relation of

−2.388 T+69.478≤C≤940/T.

The coverage ratio “C” (%) does not exceed 100%. According to the above relation, for example, when the thickness “T” is 1 μm, the coverage ratio “C” (%) is calculated to be at least 67%; when the thickness “T” is 3 μm, the coverage ratio “C” (%) is calculated to be at least 62%. For example, when the thickness “T” is 10 μm, the coverage ratio “C” (%) is calculated to be at least 46%. Therefore, the above relation is consistent with the test results indicating that a configuration in which the coverage ratio of the region R3 ranges from 70% to 80% and the thicknesses of region R3 at 1 μm, 3 μm, or 10 μm tends to suppress the deterioration of the above two characteristics.

In region R3, the hydrogen permeability coefficient at a temperature of 398 K can be set to 2.02×10 17 mol-H₂/(m·s·Pa^{1/2}) or less. Even in a configuration in which the portion R3a is formed with the region R3, the hydrogen permeability coefficient at 398 K for the combined region of the region R3 and portion R3a can be set to 2.02×10⁻¹⁷ mol-H₂/(m·s·Pa^{1/2}) or less. For example, the combined region of the region R3 and portion R3a has a hydrogen permeability coefficient at 398 K that is half or less than that of Cu at 398 K. According to the above hydrogen permeability coefficient, the region R3, regardless of the presence or absence of the portion R3a, tends to exhibit effective hydrogen diffusion inhibition characteristics and tends to suppress the deterioration of the electrical conductivity properties.

The resin included in the region R3 has the hydrogen content ratio and the hydrogen permeability coefficient similar to those of the glass included in the region R3, as described above. Therefore, it is reasonably concluded that a configuration in which the region R3 includes the resin, like a configuration in which the region R3 includes the glass, can tend to suppress the deterioration of the hydrogen diffusion inhibition properties and the electrical conductivity properties.

In the multilayer capacitor C1 according to each modification, the region R3 also includes the same material as the region R3 in the present example. Therefore, it is reasonably concluded that the multilayer capacitor C1 according to each modification, like the multilayer capacitor C1 according to the present example, can tend to suppress the deterioration of the hydrogen diffusion inhibition properties and the electrical conductivity properties.

As described above, in the multilayer capacitor C1, the external conductor 6 includes the region R3. The region R3 impedes hydrogen from migrating in the external conductor 6 from the region R2 toward the region R1. Therefore, hydrogen tends not to diffuse into the element body 3. The multilayer capacitor C1 suppresses the deterioration of characteristics thereof. For example, the multilayer capacitor C1 suppresses a decrease in the insulation resistance.

In the multilayer capacitor C1, the external conductor 6 includes the region R2. The region R2 includes the electrically conductive material. Therefore, the plating layer 9 is easily formed on the region R2. The multilayer capacitor C1 can readily adopt a configuration in which the plating layer 9 is formed on the external conductor.

In the multilayer capacitor C1, the external conductor 6 includes the region R1. The region R1 includes the electrically conductive material. Therefore, the multilayer capacitor C1 reliably maintains the electrical connection between the internal conductor (internal electrode 7) and the external conductor 6.

The region R3 may cover the side surface 3e.

In a configuration in which the region R3 covers the side surface 3e, hydrogen tends not to diffuse further into the element body 3. This configuration reliably suppresses the deterioration of characteristics of the multilayer capacitor C1.

The element body 3 may include the side surface 3a adjacent to the side surface 3e. The region R3 may cover the side surface 3a.

In a configuration in which the region R3 covers the side surface 3a, hydrogen tends not to diffuse further into the element body 3. This configuration reliably suppresses the deterioration of characteristics of the multilayer capacitor C1.

The region R1 may be in contact with the side surface 3a. The region R1 may include the portion exposed from the region R3 on the side surface 3a.

In a configuration in which the region R1 includes the portion exposed from the region R3 on the side surface 3a, the portion of the region R1 that is exposed from the region R3 can be directly connected to the region R2. The electrical connection in the external conductor 6 is improved. This configuration further reliably suppresses the deterioration of characteristics of the multilayer capacitor C1.

The region R3 may cover the region R1 with the area equal to or larger than a half of the surface area of the region R1.

In a configuration in which the region R3 covers the region R1 with the area equal to or larger than a half of the surface area of the region R1, the region R3 reliably impedes hydrogen from migrating in the external conductor 6 from the region R2 toward the region R1. Therefore, hydrogen tends not to diffuse further into the element body 3. This configuration reliably suppresses the deterioration of characteristics of the multilayer capacitor C1.

The third region may have the thickness of 1 μm or more.

In a configuration in which the third region may have the thickness of 1 μm or more, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

In the region R3, the thickness “T” (μm) of the region R3 and the coverage ratio “C” (%) of the region R3 relative to the surface of the region R1 may satisfy the relation of

$$- 2.388 T + 69.478 \leq C \leq 940 / T .$$

In a configuration in which the thickness “T” and the coverage ratio “C” satisfy the above-described relation, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The region R3 may have the hydrogen content ratio smaller than the hydrogen content ratio of each of the region R1 and the region R2. The region R3 may have the hydrogen permeability coefficient smaller than the hydrogen permeability coefficient of each of the region R1 and the region R2.

In a configuration in which the region R3 has the above-described hydrogen content ratio or the above-described hydrogen permeability coefficient, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The region R3 may include the material having the hydrogen permeability coefficient smaller than the hydrogen permeability coefficient of the electrically conductive material included in the region R1.

In a configuration in which the region R3 includes the above-described material, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The material having the hydrogen permeability coefficient smaller than the hydrogen permeability coefficient of the electrically conductive material included in the region R1 may include the glass.

In a configuration in which the above-described material includes the glass, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The region R3 may include the resin.

In a configuration in which the region R3 includes the resin, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The hydrogen permeability coefficient of the region R3 at a temperature of 398 K may be 2.02×10⁻¹⁷ mol-H₂/(m·s·Pa^{1/2}) or less.

In a configuration in which the above-described hydrogen permeability coefficient is 2.02×10⁻¹⁷ mol-H₂/(m·s·Pa^{1/2}) or less, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

The external conductor 6 may be comprised of the conductor layer 6a including the region R1, the conductor layer 6b including the region R2, and the intermediate layer 6c including the region R3.

In a configuration in which the external conductor 6 is comprised of the conductor layer 6a, the conductor layer 6b, and the intermediate layer 6c, the region R3 is reliably positioned between the region R1 and the region R2.

The conductor layer 6b including the region R2 may have the glass content smaller than the glass content of the conductor layer 6a including the region R1.

In a configuration in which the conductor layer 6b has the above-described glass content, the region R3 further reliably impedes hydrogen from migrating in the external conductor 6 from the region R2 toward the region R1. Therefore, hydrogen tends not to diffuse further into the element body 3. This configuration further reliably suppresses the deterioration of characteristics of the multilayer capacitor C1.

It is to be understood that not all aspects, advantages and features described herein may necessarily be achieved by, or included in, any one particular example. Indeed, having described and illustrated various examples herein, it should be apparent that other examples may be modified in arrangement and detail.

In the present examples and modified examples, the electronic component includes the multilayer capacitor. However, applicable electronic component is not limited to the multilayer capacitor. The applicable electronic component includes, for example, a multilayer electronic component such as a multilayer inductor, a multilayer varistor, a multilayer piezoelectric actuator, a multilayer thermistor, a multilayer solid-state battery component, or a multilayer composite component, or electronic components other than the multilayer electronic components.

What is claimed is:

1. An electronic component comprising:
an element body including a side surface;
an internal conductor disposed in the element body and including an edge that is exposed at the side surface; and
an external conductor disposed on the side surface and connected to the edge of the internal conductor,
wherein the external conductor includes:
a first region in contact with the side surface and physically connected to the edge of the internal conductor, the first region including an electrically conductive material;
a second region positioned on an outermost side of the external conductor and including an electrically conductive material; and
a third region positioned between the first region and the second region, the third region being less permeable to hydrogen than the first region and the second region.

2. The electronic component according to claim 1, wherein
the third region covers the side surface.

3. The electronic component according to claim 1, wherein
the element body includes an other side surface adjacent to the side surface, and
the third region covers the other side surface.

4. The electronic component according to claim 3, wherein
the first region is further in contact with the other side surface, and includes a portion exposed from the third region on the other side surface.

5. The electronic component according to claim 1, wherein
the third region covers the first region with an area equal to or larger than a half of a surface area of the first region.

6. The electronic component according to claim 1, wherein
the third region has a thickness of 1 μm or more.

7. The electronic component according to claim 1, wherein
in the third region, a thickness “T” (μm) of the third region and a coverage ratio “C” (%) of the third region relative to a surface of the first region satisfy a relation of
$$- 2.388 T + 69.478 \leq C \leq 940 / T .$$

8. The electronic component according to claim 1, wherein
the third region has a hydrogen content ratio smaller than a hydrogen content ratio of each of the first region and the second region, or has a hydrogen permeability coefficient smaller than a hydrogen permeability coefficient of each of the first region and the second region.

9. The electronic component according to claim 1, wherein
the third region includes a material having a hydrogen permeability coefficient smaller than a hydrogen permeability coefficient of the electrically conductive material included in the first region.

10. The electronic component according to claim 9, wherein
the material having the hydrogen permeability coefficient smaller than the hydrogen permeability coefficient of the electrically conductive material included in the first region includes glass.

11. The electronic component according to claim 1, wherein
the third region includes resin.

12. The electronic component according to claim 1, wherein
a hydrogen permeability coefficient of the third region at a temperature of 398 K is 2.02×10⁻¹⁷ mol-H₂/(m·s·Pa^{1/2}) or less.

13. The electronic component according to claim 1, wherein
the external conductor is comprised of a conductor layer including the first region, a conductor layer including the second region, and an intermediate layer including the third region.

14. The electronic component according to claim 13, wherein
the conductor layer including the second region has a glass content smaller than a glass content of the conductor layer including the first region.

15. The electronic component according to claim 1, further comprising a plating layer formed on the external conductor.
